(19) United States
(12) Patent Application Publication
(10) Pub. No.: US 2022/0090380 A1
(43) Pub. Date: Mar. 24, 2022

(54) ENCAPSULATED PREFABRICATED PANEL

(71) Applicant: NEXII BUILDING SOLUTIONS INC., Vancouver (CA)

(72) Inventors: Michael Anthony DOMBOWSKY, Moose Jaw (CA); Laurenz KOSICHEK, North Vancouver (CA)

(21) Appl. No.: 17/480,021

(22) Filed: Sep. 20, 2021

Related U.S. Application Data
(60) Provisional application No. 63/081,137, filed on Sep. 21, 2020.

(51) Int. Cl. E04C 2/288; E04C 2/38; B32B 3/04; B32B 3/08; B32B 3/06; B32B 3/26; B32B 13/04; B32B 13/14; B32B 5/18; B32B 5/02; B32B 37/15; B28B 1/30

(52) U.S. Cl. CPC E04C 2/2885; E04C 2/521; E04C 2/384; E04C 2/388; B32B 3/04; B32B 3/08; B32B 3/06; B32B 3/266; B32B 13/045; B32B 13/14; B32B 5/18; B32B 5/02; B32B 37/15; B28B 1/30; E04C 2/382

(57) ABSTRACT

Example embodiments of the described technology provide a prefabricated building panel. The prefabricated building panel may comprise an insulative core having first and second opposing faces. The prefabricated building panel may also comprise a cementitious layer encapsulating the insulative core. The cementitious layer may increase one or more performance characteristics of the panel.

### CROSS-REFERENCE TO RELATED APPLICATIONS

This application claims the benefit under 35 U.S.C. § 119 of U.S. application No. 63/081,137 filed 21 Sep. 2020 and entitled ENCAPSULATED PREFABRICATED PANEL which is hereby incorporated herein by reference for all purposes.

### FIELD

This invention relates to building panels and in particular cementitious prefabricated building panels such as Concrete Structural Insulated Panels. Example embodiments provide systems and methods for achieving desired performance characteristics.

### BACKGROUND

Constructing a building is typically an extensive project involving significant amounts of time and/or resources (labour, energy, materials, etc.). Moreover, the carbon footprint of a building built using existing systems and methods can be large.

Reducing the amount of time and/or resources required to construct a building can be desirable. Reducing the carbon footprint of a building can also be desirable. With more environmentally stringent building codes being passed regularly, reducing the amount of resources used to construct a building and the carbon footprint of the building is increasingly becoming a requirement to be in compliance with new building codes.

One way the amount of time and/or resources required can be reduced is by constructing the building using prefabricated panels. Existing prefabricated panels however are heavy, cannot provide the required performance characteristics, etc. Additionally, existing prefabricated panels may be difficult to maneuver into place and to couple together.

There remains a need for practical and cost effective ways to construct prefabricated building panels using systems and methods that improve on existing technologies.

### SUMMARY

This invention has a number of aspects. These include, without limitation:
prefabricated panels comprising an encapsulated insulative core for achieving desired performance characteristics of a prefabricated panel;
methods for constructing a prefabricated panel.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1A is a schematic perspective view of a prefabricated panel according to an example embodiment of the invention.

FIG. 1B is a schematic cutaway perspective view of the panel of FIG. 1A.

FIG. 2 is a cross-sectional view of the FIG. 1A panel along lines A-A.

FIG. 3 is a cross-sectional view of a panel according to an example embodiment of the invention.

FIG. 4 is a cross-sectional view of a panel according to an example embodiment of the invention.

FIGS. 5A to 5C are cross-sectional views of a panel according to example embodiments of the invention.

FIGS. 5D and 5E are schematic cutaway perspective views of panels according to example embodiments of the invention.

FIG. 6 is a schematic front view of a prefabricated panel according to an example embodiment of the invention.

FIG. 7A is an example cross-sectional view of the FIG. 6 panel along lines B-B.

FIG. 7B is an example cross-sectional view of a panel according to an example embodiment of the invention.

FIG. 8 is a cross-sectional view of a panel according to an example embodiment of the invention.

FIG. 9A is a schematic view of a bottom edge surface of a panel according to an example embodiment of the invention.

FIG. 9B is a partial cross-sectional view of the panel of FIG. 9A.

FIG. 10 is a block diagram illustrating a method according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the invention provides a prefabricated building panel. The prefabricated building panel comprises an insulative core. A cementitious layer may cover peripheral surfaces of the prefabricated panel. In some embodiments the cementitious layer fully encapsulates the insulative core. The cementitious layer may advantageously increase performance characteristics of the prefabricated panel. For example, the cementitious layer may increase fire resistance of the panel. As another example, the cementitious layer may increase structural strength of the panel. As another example, the cementitious layer may increase a strength of the thermal insulation provided by the panel (e.g. increase the insulative “R” value of the panel which is a measure of how good of a thermal insulator the panel is).

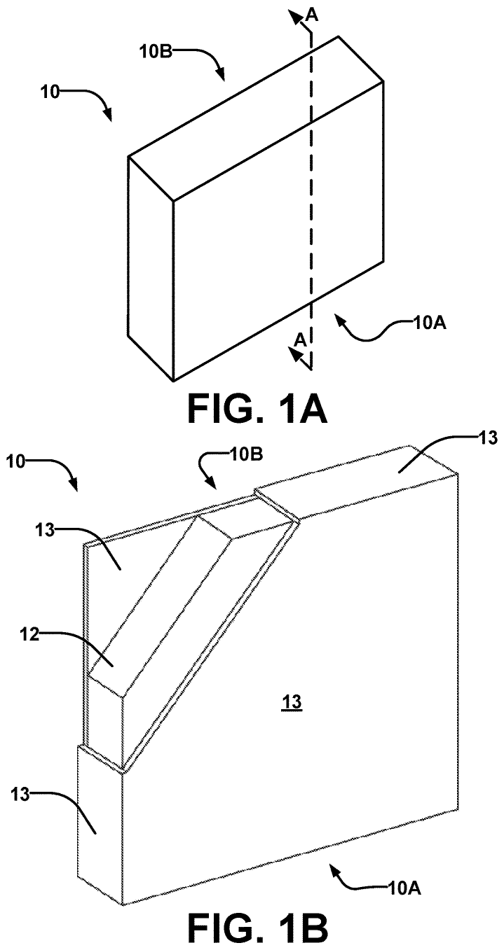

FIG. 1A schematically shows a perspective view of an example prefabricated panel 10 according to an embodiment of the invention. FIG. 1B is a schematic cutaway perspective view of panel 10 of FIG. 1A.

Panel 10 comprises opposing faces 10A and 10B. A set of panels 10 may be used to construct a building, to insulate an existing building and/or the like. Preferably panels 10 are plant finished (e.g. fully manufactured at a factory). Panels 10 may also preferably be easily and quickly shipped to a construction site (e.g. on a flatbed truck, within shipping containers, on railway cars, etc.). Panels 10 may, for example, comprise wall panels, roof panels, floor panels, foundation panels, etc. Once panels 10 arrive at the construction site they may be easily and quickly assembled together.

Panel 10 comprises an insulative core 12. Insulative core 12 provides thermal insulation for panel 10. Insulative core 12 may also at least partially structurally support panel 10. Insulative core 12 may also at least partially dampen sound transmission through panel 10. Insulative core 12 preferably comprises a single piece of insulation. However, this is not necessary. In some embodiments insulative core 12 is made of two or more pieces of insulation.

Insulative core 12 may be made of rigid foam insulation. In some embodiments insulative core 12 is made of expanded polystyrene (EPS), polyisocyanurate (polyiso), extruded polystyrene (XPS) and/or the like. In some embodiments insulative core 12 is made of mineral fiber rigid insulation. In some embodiments insulative core 12 is at least 3 inches thick. In some embodiments insulative core 12 is between 3 and 24 inches thick.

Insulative core 12 typically has an insulative R-value of about R4 per inch. In some embodiments insulative core 12 has an insulative R-value of at least R12. In some embodiments insulative core 12 has an insulative R-value of at least R96. In some embodiments insulative core 12 has an insulative R-value between R12 and R96.

Despite insulative core 12 providing one or more advantageous properties (e.g. insulative properties, sound dampening properties, structural properties, moisture resistance properties, pest resistance properties, etc.), insulative core 12 may be made of a flammable material. For example, EPS foam is petroleum based and therefore may be flammable. When exposed to heat (e.g. during a fire), insulative core 12 may contract and shrink. Additionally, or alternatively, insulative core 12 may melt thereby transitioning from a solid state to a liquid state. Insulative core 12 in a liquid state may flow into open flames (or other ignition sources) and ignite. In some cases having an ignited insulative core 12 may result in a building being engulfed in a deadly inferno.

As shown in FIG. 1 panel 10 comprises a cementitious layer 13 encapsulating insulative core 12. “Encapsulating” means that cementitious layer 13 encloses the surfaces of insulative core 12. In currently preferred embodiments, cementitious layer 13 encloses all of the surfaces of insulative core 12.

By encapsulating insulative core 12 with cementitious layer 13, cementitious layer 13 provides a barrier isolating insulative core 12 from potential ignition sources (e.g. open flames, sparks, flying embers, etc.). In cases where insulative core 12 has at least partially liquefied, cementitious layer 13 may also provide a barrier preventing insulative core 12 from leaking out of panel 10.

Additionally, or alternatively, encapsulating insulative core 12 with cementitious layer 13 may increase the structural strength of panel 10. In some cases, encapsulating insulative core 12 with cementitious layer 13 effectively may produce a panel 10 having structural strength properties as though the panel was made of a single block of cementitious material.

Additionally, or alternatively, encapsulating insulative core 12 with cementitious layer 13 may increase the strength of the thermal insulation provided by panel 10. In some embodiments, cementitious layer 13 increases the strength of the thermal break provided by insulative core 12 between faces 10A and 10B of panel 10.

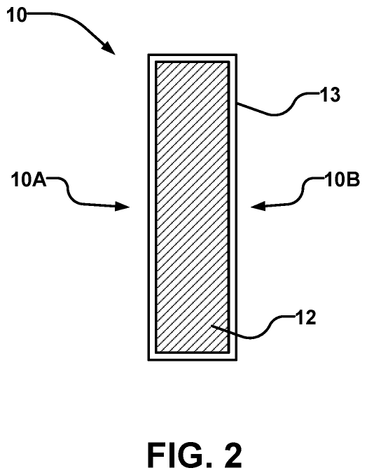

FIG. 2 is a cross-sectional view of an example panel 10 along the plane formed by line A-A of FIG. 1A.

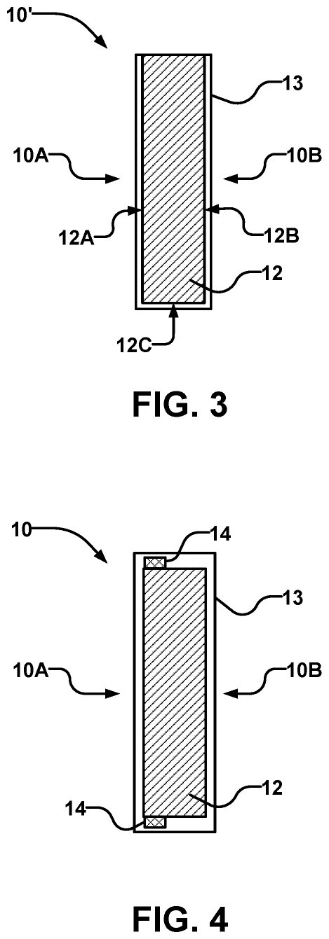

In currently preferred embodiments, as described elsewhere herein, cementitious layer 13 covers all surfaces of insulative core 12 (e.g. cementitious layer 13 fully encloses insulative core 12). However, this is not mandatory in all cases. Depending on an intended use of a panel 10, cementitious layer 13 may only enclose a portion of the peripheral surfaces of insulative core 12. How much of the periphery of insulative core 12 is enclosed by cementitious layer 13 may depend on an intended use of panel 10. For example, as shown in FIG. 3, five peripheral surfaces of insulative core 12 (e.g. surfaces 12A, 12B and 12C and two end surfaces) of a panel 10′ may be enclosed with cementitious layer 13. Example panel 10′ is intended to be used as a vertical wall panel. In such example case, enclosing the top peripheral edge surface of example vertical wall panel 10′ with cementitious layer 13 may be unnecessary (e.g. other like panels stack on top of panel 10′, a panel may stack horizontally over panel 10′, etc.).

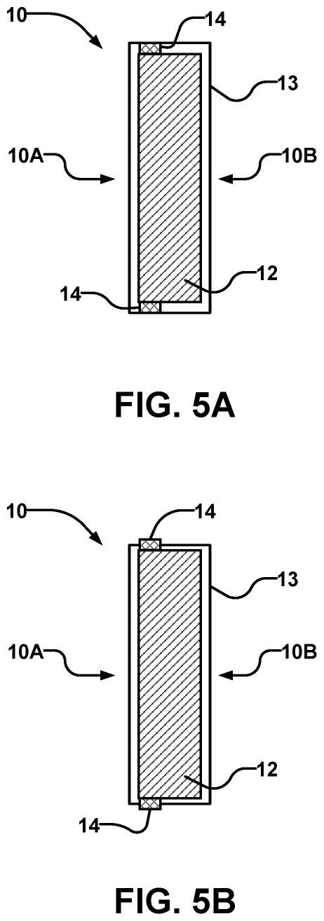

To increase the structural strength of panel 10, panel 10 may comprise a structural frame and/or one or more structural elements (e.g. studs extending through insulative core 12, braces, ribs, beams, etc.). For example, panel 10 may comprise a structural frame 14 which surrounds at least part of insulative core 12 as shown in FIG. 4. In FIG. 4 structural frame 14 is shown as being closer to one face of panel 10 than the opposing face. The position of structural frame 14 relative to insulative core 12 may not be the same in all cases. In some embodiments structural frame 14 is closer to face 10A of panel 10 than face 10B. In some embodiments structural frame 14 is closer to face 10B of panel 10 than face 10A. In some embodiments structural frame 14 is centered relative to insulative core 12 (e.g. located an equal distance between faces 10A and 10B).

Structural frame 14 need not extend around an entire periphery of insulative core 12. In some embodiments structural frame 14 only partially extends around the edges of insulative core 12.

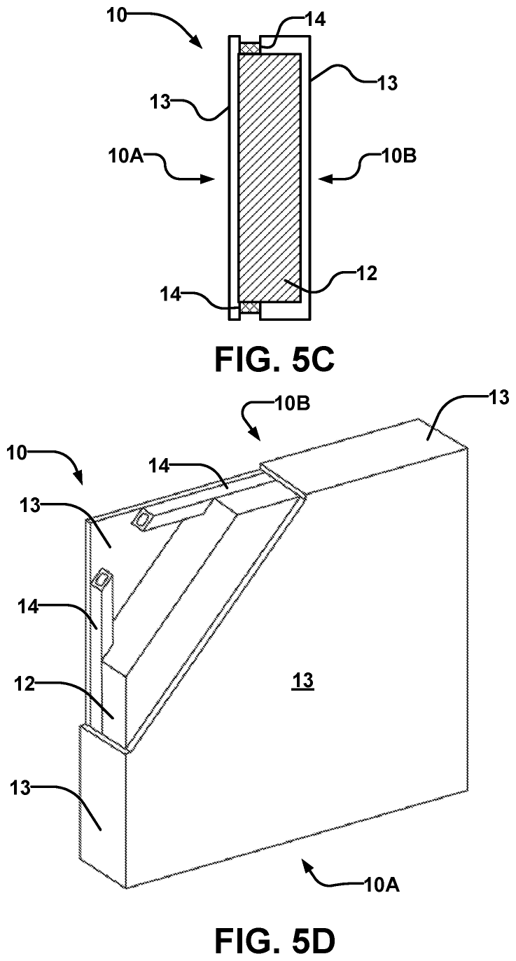

In currently preferred embodiments cementitious layer 13 also encapsulates structural frame 14 (see e.g. FIG. 4). However in some cases cementitious layer 13 does not fully encapsulate structural frame 14. In some embodiments cementitious layer 13 is:
flush with an outer surface of structural frame 14 (see e.g. FIG. 5A);
lower than an outer surface of structural frame 14 (see e.g. FIG. 5B);
higher than an outer surface of structural frame 14 (see e.g. FIG. 5C).
   In some embodiments cementitious layer 13 has a different thickness on either side of structural frame 14.

In some embodiments cementitious layer 13 chemically bonds to structural frame 14. Preferably in such embodiments structural frame 14 is cleaned and/or prepared prior to cementitious layer 13 being bonded to structural frame 14. For example, structural frame 14 may be cleaned and/or prepared by sand blasting, by using a mechanical abrasive grinding technique and/or the like.

In some embodiments cementitious layer 13 is physically coupled to structural frame 14. For example, a reinforcing mesh (e.g. welded wire mesh, fiberglass reinforcing mesh, etc.), forming pins, and/or the like may be coupled to structural frame 14. The reinforcing mesh may be coupled to structural frame 14 using fasteners, welded to structural frame 14, etc. Cementitious layer 13 may be poured over the reinforcing mesh thereby embedding the reinforcing mesh within cementitious layer 13 and coupling cementitious layer 13 to structural frame 14.

Structural frame 14 may comprise, for example, structural steel (e.g. hollow structural section steel (HSS), I-Beam steel, C-channel steel, etc.), cementitious material, reinforced cementitious material, structural fiberglass, aluminum, carbon fiber and/or the like.

FIG. 5D is a schematic cutaway perspective view of panel 10 having a structural steel frame 14 which comprises structural steel. FIG. 5E is a schematic cutaway perspective view of panel 10 having a structural frame 14 which comprises reinforced cementitious material (e.g. cementitious material reinforced with re-bar). The cementitious material may be the same or different than the cementitious material of cementitious layer 13.

Panel 10 may also comprise at least one connector. The connector may be coupled to (or be a part of) a structural frame of panel 10 (e.g. structural frame 14 described elsewhere herein). However, this is not necessary in all cases. The connector may be coupled directly to insulative core 12 in some embodiments. The connector may, for example, be used to couple panel 10 to an adjacent panel 10 or another panel or structure that are part of a building under construction. Additionally, or alternatively, the connector may be used to couple panel 10 to an existing building.

In some embodiments the connector comprises at least one aperture for receiving a connecting element (i.e. an element used to couple the connector to another component of the structure under construction). In some embodiments the connector comprises a cavity through which the connecting element may be accessed (e.g. to couple a nut to the end of the connecting element). In some embodiments the connector is a hollow steel element (e.g. a hollow rectangular steel section). In some embodiments the connector is like the connector(s) described in U.S. Patent Application No. 63/003,401 filed 1 Apr. 2020 and entitled SYSTEMS AND METHODS FOR COUPLING PREFABRICATED PANELS TOGETHER, which is hereby incorporated by reference for all purposes.

In currently preferred embodiments the connector is also encapsulated by cementitious layer 13. However, at least a portion of the connector may initially be left unencapsulated (e.g. to allow coupling of panels). Once the panels are coupled (e.g. coupled together, coupled to a building, etc.) the connector may be further encapsulated with cementitious layer 13. In some embodiments the connector is fully encapsulated with cementitious layer 13 once a panel is coupled. In some embodiments a block of cementitious layer covers the connector. The block of cementitious layer may comprise a cementitious material that is the same or different than the cementitious material of cementitious layer 13.

In some embodiments the connector is covered with drywall or the like. A joint formed between the drywall and a face of panel 10 may be covered with, for example, mesh tape and gypsum mud.

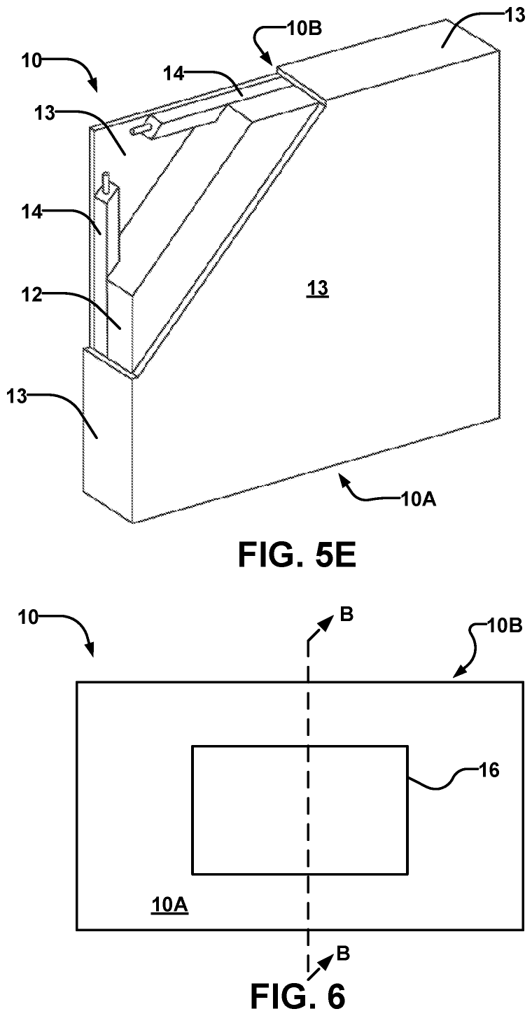

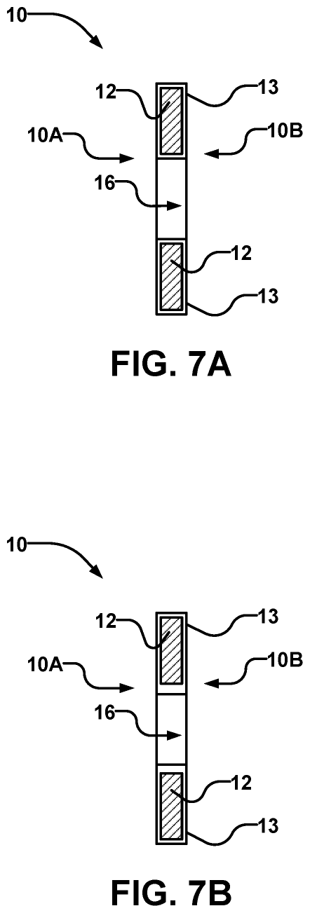

Panel 10 may comprise one or more openings 16 for receiving windows, doors, etc. as shown in FIG. 6. In such cases cementitious layer 13 may enclose one or more of the edge surfaces of insulative core 12 which define opening 16. In currently preferred embodiments all edge surfaces of insulative core 12 which define opening 16 are enclosed by cementitious layer 13. This is shown, for example, in FIG. 7A which is a cross-sectional view of panel 10 along the plane formed by line B-B of FIG. 6.

Portions of cementitious layer 13 which enclose the edge surfaces of an opening 16 may have the same or different thickness as portions of cementitious layer 13 which enclose other surfaces of panel 10. Removing portions of panel 10 (e.g. insulative core 12, cementitious layer 13, etc.) to create opening 16 may reduce the structural strength of panel 10. To compensate for the reduced structural strength, in some embodiments, portions of cementitious layer 13 which surround edge surfaces of an opening 16 are thicker than the remaining portions of cementitious layer 13 (see e.g. FIG. 7B). Varying the thickness of portions of cementitious layer 13 which surround edge surfaces of an opening 16 may additionally, or alternatively, vary fire resistance properties (e.g. thicker portions may have higher fire resistance), vary thermal insulation properties (e.g. increasing thickness may increase thermal insulation in some cases), etc.

In some embodiments portions of cementitious layer 13 which enclose the edge surfaces of an opening 16 may comprise integrated architectural features. For example, such portions of cementitious layer 13 may comprise drip edges, moisture channels (e.g. to direct moisture away from the opening), sloped sills, edge and/or molding detailing (e.g. chamfers, round-over edges, etc.), ledges, a flashing end dam, etc. Additionally, or alternatively, such portions of cementitious layer 13 may comprise one or more reinforcing members (e.g. re-bar, wire mesh, etc.).

Additionally, or alternatively, portions of cementitious layer 13 which enclose the edge surfaces of an opening 16 may provide one or more surfaces for fastening features to panel 10. For example, a window intended to be installed within an opening 16 may be fastened to panel 10 through cementitious layer 13 which encloses the edge surfaces of the opening. Cementitious layer 13 may advantageously provide a surface into which fasteners (e.g. nails, screws, bolts, etc. may be secured.

Cementitious layer 13 is typically made of a cementitious material having a high thermal resistance. For example, cementitious layer 13 may be made of a cementitious layer that can last 2 hours at 1800 degrees Fahrenheit, is compliant with fire resistant standards (e.g. CAN/ULC-S101 Fire-Resistance Ratings, etc.) and/or the like.

Cementitious layer 13 is preferably directly coupled to insulative core 12. For example, cementitious layer 13 may be wet-bonded to surfaces of insulative core 12.

Panel 10 may comprise utility and/or service lines running through panel 10 such as electrical lines, plumbing, HVAC ducting, gas lines, central vacuum lines, etc. The utility and/or service lines may be interconnected between panels and thereby may extend beyond a cementitious layer 13 of a panel 10. To maintain the barrier provided by cementitious layer 13, panel 10 may comprise, for example (non-limiting):
channels for running the utility and/or service lines which have walls entirely enclosed with cementitious layer 13;
cementitious caps enclosing the empty space between a utility and/or service line and insulative core 12, the caps made from the same or different material as the material of cementitious layer 13;
one or more coverings which enclose an opening used to run a utility and/or service line, the coverings comprising intumescent fire caulking or other types of first stop packing or wadding (e.g. mineral fiber insulation);
etc.

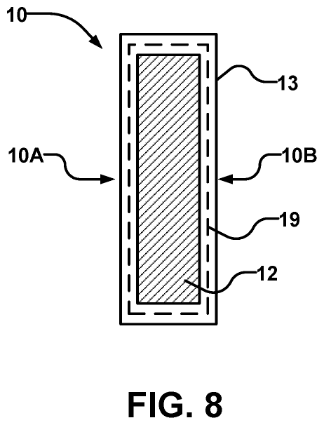

Optionally panel 10 may comprise one or more reinforcing members 19 embedded within cementitious layer 13. Advantageously, reinforcing members 19 may increase structural strength of the cementitious coverings, prevent cracking of the cementitious coverings and/or the like. Although FIG. 8 shows reinforcing members 19 embedded within cementitious layer 13, reinforcing members 19 may be partially embedded within cementitious layer 13 and partially embedded within insulative core 12. Additionally, or alternatively, reinforcing members 19 need not extend throughout all of cementitious layer 13.

Reinforcing members 19 may be made of:
expanded metal mesh (EMM);
welded wire mesh (WMM);
fiberglass mesh;
basalt mesh and/or rebar;
carbon fiber mesh and/or rebar;
carbon nanotubes;
Kevlar;
steel and/or stainless steel rebar;
etc.

In some embodiments reinforcing members 19 may comprise a plurality of fibers. For example, reinforcing members 19 may comprise a plurality of polymer fibers, a plurality of fiberglass fibers, a plurality of basalt fibers, a plurality of carbon fiber fibers and/or the like.

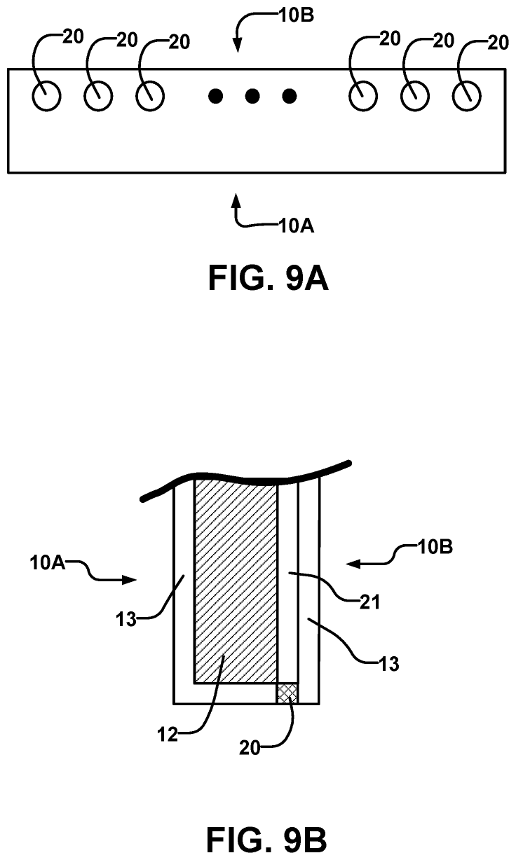

In some embodiments panel 10 comprises one or more wicks 20 (see e.g. FIG. 9A which is a bottom view of example panel 10). FIG. 9B is a partial cross-sectional view of an example bottom edge of panel 10 which comprises a wick 20.

Cementitious layer 13 may have a low moisture permeability. By incorporating one or more wicks 20, the inventors have discovered that any moisture that may be within panel 10 (e.g. within insulative core 12) may escape outside of the panel via the one or more wicks 20. Wicks 20 preferably comprise a material having a moisture permeability that is higher than the moisture permeability of cementitious layer 13. In currently preferred embodiments wicks 20 comprise a material that is fire resistant. In some embodiments the material of wicks 20 has a fire resistance that is the same or higher than the fire resistance of cementitious layer 13. The material of wicks 20 also preferably prevents core 12 (e.g. a melted insulative core 12) from escaping panel 10 during a fire.

In currently preferred embodiments the material of wicks 20 is also pest resistant (e.g. prevents pests such as insects (ants, termites, etc.), snakes, rodents, etc. from penetrating into panel 10.

Wicks 20 may be spaced apart by equal distances. However, this is not mandatory.

In currently preferred embodiments wicks 20 are incorporated into bottom edges of panel 10. However wicks 20 may be incorporated into any edge surface of panel 10. In some embodiments two or more edge surfaces of panel 10 comprise at least one wick 20 each.

In some embodiments one or more faces of insulative core 12 comprise grooves (e.g. see example groove 21 in FIG. 9B) for directing any moisture that penetrates into panel 10. Wicks 20 may be located at an end (e.g. a bottom end) of such grooves. In such embodiments panel 10 comprises a number of wicks 20 that is equal to the number of grooves in insulative core 12.

In some embodiments panel 10 comprises between 1 and 20 wicks. In some embodiments panel 10 comprises between 1 and 10 wicks.

In some embodiments different portions of cementitious layer 13 which cover different surfaces of panel 10 have different thickness. For example, portions of cementitious layer 13 which cover edge surfaces (e.g. the four edge surfaces of a rectangular panel which define faces 10A and 10B) of panel 10 may be thinner than portions of cementitious layer 13 which cover faces 10A and 10B of panel 10 or vice versa. By reducing a thickness of at least some portions of cementitious layer 13, the weight of panel 10 may be decreased while maintaining desired performance characteristics (e.g. maintaining a desired fire resistance, a desired structural strength (e.g. the panel could be load bearing if required structural strength is met), desired insulative properties, etc.).

In some embodiments the thinner portions of cementitious layer 13 may have a thickness between about ¼ of any inch to about ½ of an inch. In currently preferred embodiments the thinner portions of cementitious layer 13 do not introduce a thermal bridge.

In some embodiments cementitious layer 13 has a uniform thickness throughout.

Another aspect of the invention provides a method for constructing a prefabricated panel.

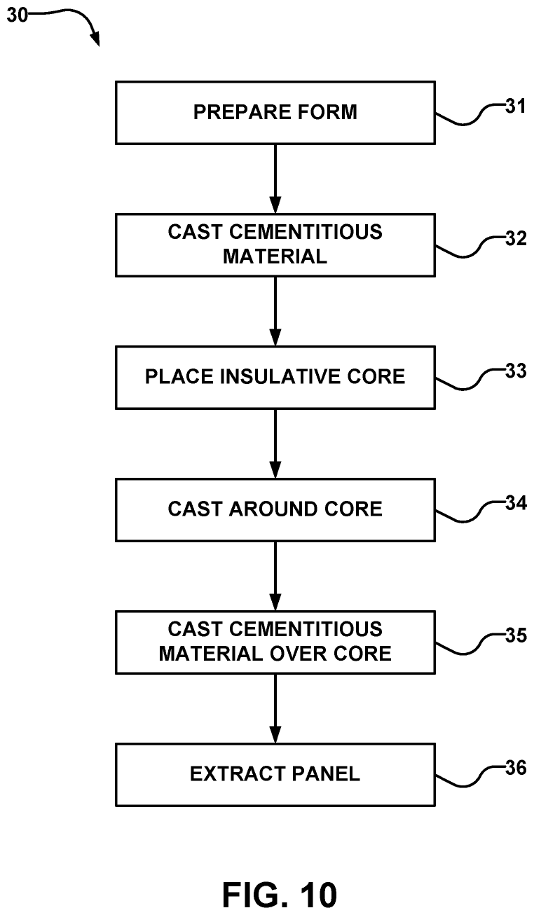

FIG. 10 illustrates an example method 30 for constructing panel 10 described elsewhere herein.

In block 31 a form for casting the panel is prepared. The form may comprise one or more features to assist with extraction of a completed panel. Such features may include rounded interior corners, formwork that may be quickly uncoupled, etc.

In block 32 a layer of cementitious material is poured into the form. In block 33 an insulative core is placed over the poured layer. In some embodiments a structural frame surrounds the insulative core prior to the insulative core being placed over the poured layer.

In block 34 gaps between the insulative core and the sides of the form are filled with poured cementitious material. In block 35 a layer of cementitious material is poured over the insulative core. In some embodiments blocks 34 and 35 are combined into a single step. In block 36 the panel is extracted from the form.

The cementitious material may be wet bonded to the insulative core (e.g. the cementitious layer “self-adheres” to the faces of insulative core 12). The “wet-bonding” may provide an adhesive chemical bond directly between two surfaces that are to be coupled together (e.g. a face of the insulative core and the cementitious layer).

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A prefabricated building panel, the panel comprising:
an insulative core having first and second opposing faces; and
a cementitious layer substantially encapsulating the insulative core.

2. The panel of claim 1 wherein the cementitious layer increases at least one of fire resistance, structural strength and thermal insulative strength of the panel.

3. The panel of claim 1 wherein the cementitious layer covers at least five surfaces of the insulative core.

4. The panel of claim 1 wherein the cementitious layer covers all surfaces of the insulative core.

5. The panel of claim 1 further comprising at least one wick embedded within the cementitious layer, the at least one wick comprising a material having a higher moisture permeability than the cementitious layer.

6. The panel of claim 5 wherein the at least one wick is embedded in a portion of the cementitious layer which covers a bottom edge surface of the panel.

7. The panel of claim 5 further comprising a plurality of wicks.

8. The panel of claim 7 wherein the first face of the insulative core comprises a plurality of grooves configured to direct moisture, each of the plurality of wicks aligned with an end of one groove of the plurality of grooves.

9. The panel of claim 1 further comprising a structural frame.

10. The panel of claim 9 wherein the structural frame surrounds the insulative core.

11. The panel of claim 9 wherein the cementitious layer encapsulates the structural frame.

12. The panel of claim 9 wherein the structural frame is closer to the first face of the insulative core than the second face.

13. The panel of claim 9 wherein the structural frame comprises at least one of structural steel, cementitious material, reinforced cementitious material, structural fiberglass, aluminum and carbon fiber.

14. The panel of claim 1 further comprising at least one connector for coupling the panel to an adjacent panel or an existing structure.

15. The panel of claim 14 wherein the cementitious layer at least partially encapsulates the connector.

16. The panel of claim 1 wherein the insulative core defines an aperture for receiving at least one of a window and a door, the cementitious layer at least partially encapsulating surface edges of the insulative core which define the aperture.

17. The panel of claim 16 wherein the cementitious layer encapsulates all of the surface edges of the insulative core which define the aperture.

18. The panel of claim 16 wherein portions of the cementitious layer which encapsulate the surface edges of the insulative core which define the aperture are thicker than remaining portions of the cementitious layer.

19. The panel of claim 1 wherein portions of the cementitious layer which encapsulate edges of the insulative core which surround the first and second opposing faces are thinner than remaining portions of the cementitious layer.

20. The panel of claim 19 wherein the portions of the cementitious layer which encapsulate the edges of the insulative core which surround the first and second opposing faces have a thickness between ¼ inch and ½ inch.

21. A method of fabricating a prefabricated panel, the method comprising:
casting a cementitious material;
placing an insulative core over the cast cementitious material; and
casting the cementitious material over remaining portions of the insulative core, the cementitious material substantially encapsulating the insulative core.
